(19) United States
(12) Patent Application Publication
(10) Pub. No.: US 2017/0034598 A1
(43) Pub. Date: Feb. 2, 2017

(54) Sensor Interface Adapter Board

(71) Applicant: Savannah River Nuclear Solutions, LLC, Aiken, SC (US)

(72) Inventors: Robert F. Fogle, Aiken, SC (US); Larry E. Feutral, Aiken, SC (US)

(73) Assignee: Savannah River Nuclear Solutions, LLC

(21) Appl. No.: 14/810,753

(22) Filed: Jul. 28, 2015

(51) Int. Cl. H04Q 9/00; G01D 11/30

(52) U.S. Cl. CPC H04Q 9/00; G01D 11/305; H04Q 2209/40

(57) ABSTRACT

A sensor interface board is provided for coupling one or more sensor devices to one or more electrical components of a host device. In particular, the sensor interface board can include a printed circuit board and one or more miniaturized connectors. The printed circuit board can have a circuit configuration made up of one or more traces coupling together one or more electrical contact points. The miniaturized connectors can be configured to connect to one or more sensors. In this manner, when the one or more sensors are connected to the miniaturized connectors, a conductive path can be formed between the sensor devices and one or more electrical terminals on the host device via the circuit configuration of the sensor interface board.

### STATEMENT AS TO RIGHTS TO INVENTIONS MADE UNDER FEDERALLY SPONSORED RESEARCH AND DEVELOPMENT

This invention was made with Government support under Contract No. DE-AC09-085R22470 awarded by the United States Department of Energy. The Government has certain rights in the invention.

### FIELD

The subject matter of the present disclosure generally relates to sensor devices, and more particularly, to systems and methods for coupling one or more sensor devices to one or more electrical terminals via a sensor interface board.

### BACKGROUND

Various sensor devices can be used to detect data, such as for instance, data relating to temperature, flow, vibration, pressure, motion, weather, etc. Such sensors can include wireless transmitters configured to transmit data. Various wireless sensors systems can be used as part of a sensor network to measure data and provide the data to a digital control or acquisition system. Conventional sensors can include very small gauge (e.g. 28 AWG or smaller) wires that may be inconvenient to work with and/or easily broken. In particular, such wires can be used as leads to couple the sensor to various electrical components such as a power source for a wireless transmitter and/or various other suitable electrical components. In conventional sensor systems, the sensor wires can be connected to screw or similar terminals associated with the appropriate electrical components.

For instance, FIG. 1 depicts an example conventional system 100 wherein two sensor devices (not shown) are connected to a host transmitting device. In this case, vibration sensors are connected to a battery adapter in a wireless vibration transmitter using 28 AWG wires as leads. Each sensor includes a power lead 102, a signal lead 104, and a common lead 106. The leads 102-106 are connected directly under terminal screws 101, 103, 105, and 107 in accordance with a desired circuit functionality. In particular, the leads 102-106 are positioned beneath terminal screws 101-107, such that they form a conductive connection with terminal screws 101-107. Common practice for connecting two sensors is to twist together the power leads 102 of the two sensors in order to secure the power leads 102 under a single terminal, and to do the same for the common leads 106. Such a configuration may cause damage to the leads 102-106. For instance, terminal screws 101-107 can crush and/or break the leads 102-106 if tightened too tightly. Further, to remove one sensor, both sensor leads 102 and 106 must be untwisted. This can cause damage to one or both of the sensor leads.

Accordingly, there is a need for a convenient and efficient technique for providing sensor connections to one or more electrical screw or similar terminals without damaging the small gauge wires.

### SUMMARY

Aspects and advantages of the invention will be set forth in part in the following description, or may be obvious from the description, or may be learned through practice of the invention.

One example aspect of the present disclosure is directed to a sensor interface board including a printed circuit board having a circuit pattern comprising one or more conductive traces and a plurality of electrical contact points. The one or more traces are configured to couple together at least two contact points of the plurality of contact points. The printed circuit board further has a plurality of terminal screw holes. At least one of the plurality of electrical contact points is associated with a terminal screw hole. The sensor interface board further includes one or more connectors located on the sensor interface board. The one or more connectors are configured to couple a sensor device to at least one electrical terminal associated with an electrical component via at least a portion of the circuit pattern of the printed circuit board. The sensor interface board is configured to be secured in place relative to the electrical component by one or more terminal screws configured to be secured in place relative to the electrical component by one or more terminal screws configured to fit in the plurality of terminal screw holes. When the one or more terminal screws are tightened, a conductive path is formed between the sensor device and the electrical component.

These and other features, aspects and advantages of the present invention will become better understood with reference to the following description and appended claims. The accompanying drawings, which are incorporated in and constitute a part of this specification, illustrate embodiments of the invention and, together with the description, serve to explain the principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended figure(s), in which:

FIG. 1 depicts an example conventional sensor system connect to a host transmitting device;

FIG. 2 depicts an example sensor interface board according to example embodiments of the present disclosure;

FIG. 3 depicts an example sensor interface board mounted to an electrical component of the host device according to example embodiments of the present disclosure;

FIG. 4 depicts sensor system having a sensor interface board according to example embodiments of the present disclosure;

FIG. 5 depicts an example circuit configuration of a sensor interface board according to example embodiments of the present disclosure; and

FIG. 6 depicts an example circuit configuration of a sensor interface board according to example embodiments of the present disclosure.

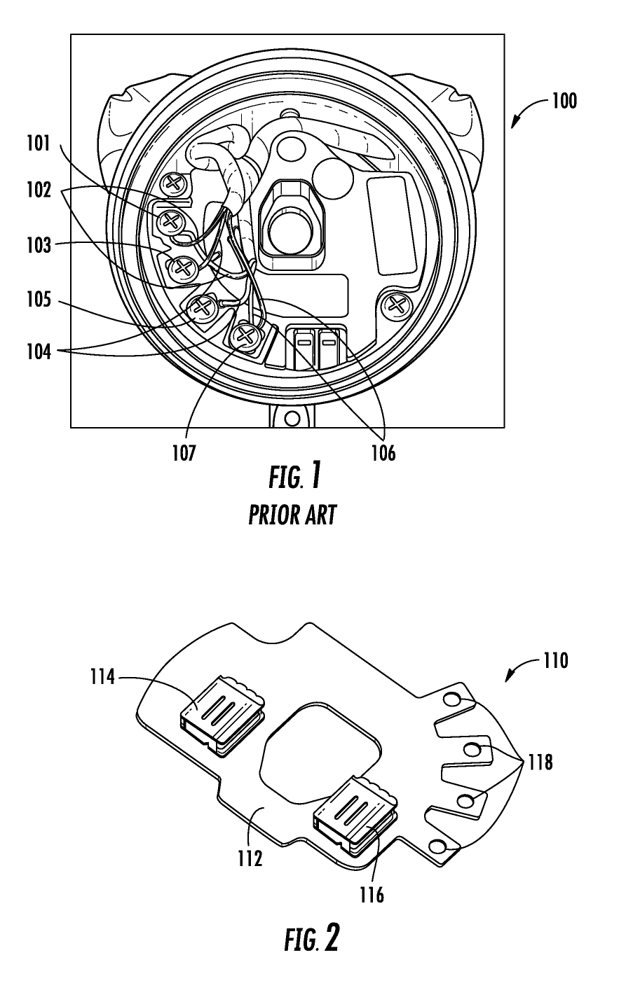

### DETAILED DESCRIPTION

Reference now will be made in detail to embodiments of the invention, one or more examples of which are illustrated in the figure(s). Each example is provided by way of explanation of the invention, not limitation of the invention. In fact, it will be apparent to those skilled in the art that various modifications and variations can be made in the present invention without departing from the scope or spirit of the invention. For instance, features illustrated or described as part of one embodiment can be used with another embodiment to yield a still further embodiment. Thus, it is intended that the present invention covers such modifications and variations as come within the scope of the appended claims and their equivalents.

Example aspects of the present disclosure are directed to systems and methods for providing a conductive path between one or more sensor devices and various electrical components. More particularly, aspects of the present disclosure provide a sensor interface board that includes one or more connectors. The connectors can be used as receptacles for corresponding sensor connectors associated with one or more sensor devices. In example embodiments, the interface board connectors can be miniaturized, right angle connectors.

The sensor interface board can further include a printed circuit board having circuitry configured to couple the connectors to the various electrical components. In particular, the sensor interface board can include various circuit arrangements that can be used to facilitate desired circuit functionalities. For instance, the sensor interface board can include various conductive trace configurations that can be used to couple the connectors to various suitable electrical components. In this manner, the conductive traces can be configured to provide a conductive path between various electrical contact points located on the printed circuit board. The electrical contact points can be conductive points on the sensor interface board, such that a conductive connection is formed when the contact points make contact with an electrical terminal and/or a sensor interface board connector. Accordingly, when a sensor connector is connected to a corresponding sensor interface board connector, the sensor can be coupled to one or more electrical terminals via the sensor interface board.

In example embodiments, the sensor interface board can be secured in place by various terminal screws, such that when the screws are tightened, conductive contact is made with one or more electrical contact points on the sensor interface board, and a conductive path is formed between the connectors of the sensor interface board and the terminals of the electrical components. When a sensor connector is subsequently connected to a sensor interface board connector, an electrical connection can be formed between the sensor and the electrical component(s). In this manner, the sensor interface board can provide an efficient, secure connection between the sensors and the electrical components of the host transmitting device.

For instance, FIG. 2 depicts an example sensor interface board 110 according to example embodiments of the present disclosure. Sensor interface board 110 includes a printed circuit board 112 and connectors 114 and 116. Printed circuit board 112 can include one or more non-conductive substrates formed, for instance, from material such as silicon, silicon dioxide, aluminum oxide, sapphire, germanium, gallium arsenide, an alloy of silicon and germanium, or indium phosphide, or various other suitable materials. Printed circuit board 112 can be a single-sided circuit board, a double-sided circuit board, or a multi-layered circuit board. Printed circuit board 112 can include various circuit configurations to couple connector 114 and/or connector 116 to one or more electrical components. In particular, printed circuit board 112 can include various circuit patterns, which can be implemented using conductive traces, pads, electrical contact points, and/or various suitable electrical components (e.g. resistors, capacitors, transistors, diodes, integrated circuit chips, etc.) For instance, the circuit patterns can be, at least in part, etched from copper sheets laminated onto the substrate. It will be appreciated that various other suitable printed circuit board materials, designs, and/or manufacturing techniques can be used without deviating from the scope of the present disclosure.

As depicted, connectors 114 and 116 can be miniaturized, right angle connectors, although various other suitable connector types can be used. Connectors 114 and 116 can have various suitable contact point configurations, such as a two contact point configuration, three contact point configuration, four contact point configuration, etc. In particular, the contact point configuration of connectors 114 and 116 can be selected based at least in part on a lead configuration of one or more sensor devices to be coupled to connectors 114 and 116. The leads of the sensor devices can be terminated in a sensor connector configured to be received by connector 114 and/or connector 116. The leads can form a contact with the contact points of connectors 114 and/or 116, which can further form a contact with one or more contact points of sensor interface board 110, thereby coupling the sensor devices to sensor interface board 110.

Sensor interface board 110 can further include one or more terminal screw holes, such as screw holes 118. As will be described below, screw holes 118 can be configured to secure sensor interface board 110 in place relative to a screw terminal interface associated with a wireless transmitter or other suitable screw terminal interface. Screw holes 118 can further be configured to couple the circuitry of printed circuit board 112 to various electrical components associated with the wireless transmitter or other device containing a screw terminal system via one or more electrical contact points associated with screw holes 118.

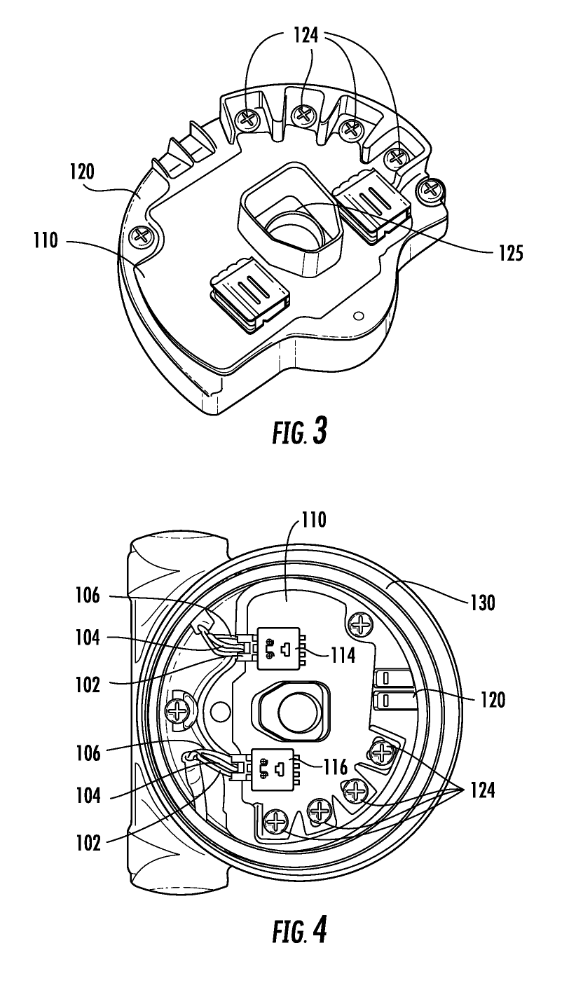

For instance, FIG. 3 depicts an example sensor interface board 110 mounted to a battery adapter 120 associated with a wireless transmitter according to example embodiments of the present disclosure. Battery adapter 120 can include various terminal screws 124 that can fit in screw holes 118 of sensor interface board 110. Although four terminal screws 124 are depicted, it will be appreciated that various other suitable numbers of terminal screws can be used without deviating from the scope of the present disclosure. When tightened, terminal screws 124 can secure sensor interface board 110 in place relative to battery adapter 120. Further, when tightened, terminal screws 124 can make contact with one or more electrical contact points associated with screw holes 118, which can conductively couple sensor interface board 110 to various electrical components. Battery adapter 120 can further include a battery connector 125. In particular, battery connector 125 can be configured to receive a battery module, and/or other power source, which can be used to power one or more electrical components, wireless transmitters, and/or sensor devices associated with battery adapter 120. Accordingly, when the battery module is connected to battery connector 125, terminal screws 124 are fit in screw holes 118 and tightened, and the sensor connectors are connected to connectors 114 and/or 116, a conductive path can be formed between the sensor devices and the electrical terminals via the sensor interface board.

Sensor interface boards, such as sensor interface board 110 can be used in various suitable applications. For instance, FIG. 4 depicts an example sensor system 130 according to example embodiments of the present disclosure. In example embodiments sensor system 130 can be a wireless vibration transmitter, or other suitable sensor system having a screw terminal interface. System 130 can include one or more sensors (not shown) coupled to system 130 via sensor interface board 110. For instance, system 130 can include two accelerometers (or other suitable sensor devices) configured to detect and measure a level of vibration. In particular, the sensors can have one or more leads, such as leads 102-106. The leads of each sensor can be terminated in a sensor connector, which can be configured to fit in connector 114 and/or connector 116 of sensor interface board 110. As described above, when connected, an electrical path can be formed between and the sensors and the various terminals (e.g. using terminal screws 124) associated with battery adapter 120 via the various circuit patterns of sensor interface board 110.

Sensor interface board 110 can have various circuit pattern configurations. In particular, such circuit pattern configurations can be configured to correspond to various sensor characteristics and/or functionalities. For instance, FIG. 5 depicts an example circuit configuration 140 of a sensor interface board according to example embodiments of the present disclosure. In particular, circuit configuration 140 can be configured to correspond to a vibration transmitter. Circuit configuration 140, in conjunction with one or more suitable sensor devices, can be configured to facilitate the transmission of one or more signals indicative of a level of vibration, as detected by the one or more sensor devices.

Circuit configuration 140 can include various contact points (e.g. connector contact points 146, 147, 148, 149, 150, 151 and terminal contact points 152, 153, 154, 155). Connector contact points 146-151 can be configured to couple circuit configuration 140 to one or more connectors (e.g. connectors 114, 116). Terminal contact points 152-155 can be configured to couple circuit configuration 140 to one or more electrical terminals (e.g. using one or more terminal screws).

Circuit configuration 140 can further include various traces (e.g. traces 141, 142, 143, 144, 145). The traces 141-145 can be formed from copper (or various other suitable materials) using subtractive, additive, and/or semi-additive techniques. As shown, the traces 141-145 can be configured to couple connector contact points 146-151 to terminal contact points 152-155 in accordance with a desired circuit functionality (e.g. vibration transmission). For instance, trace 141 can be configured to couple connector contact point 146 to terminal contact point 152, trace 142 can be configured to couple connector contact point 147 to terminal contact point 153, etc.

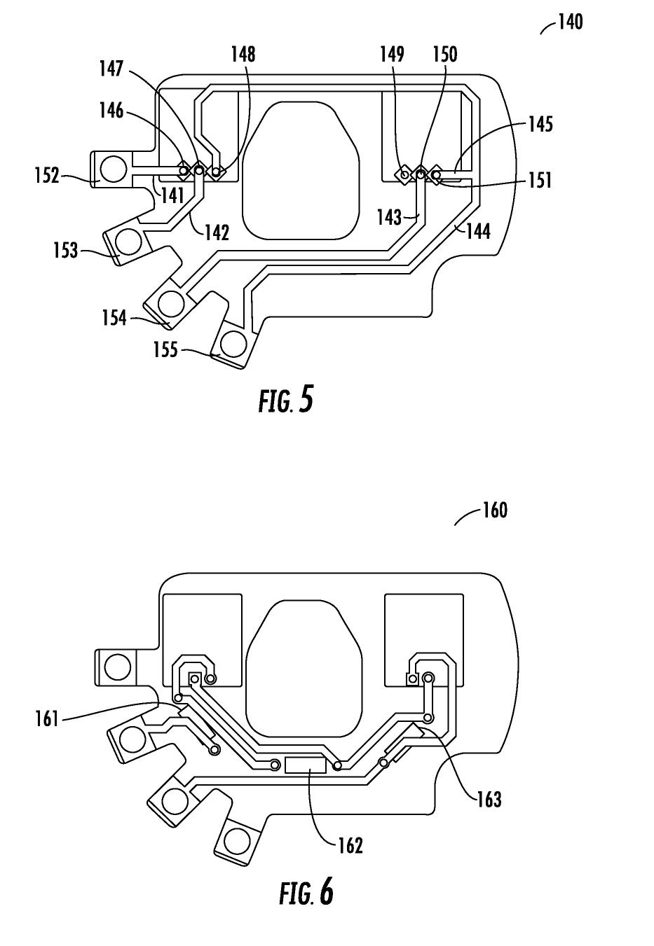

Various other circuit pattern configurations can be used using various other suitable materials and/or designs. For instance, FIG. 6 depicts an example circuit configuration 160 according to example embodiments of the present disclosure. Similar to circuit configuration 140, circuit configuration 160 includes various traces and various contact points (e.g. connector contact points and terminal contact points) on a printed circuit board. Circuit configuration 160 further includes resistors 161, 162, and 163. In example embodiments, resistors 161-163 can be coupled to the printed circuit board using surface mount and/or through hole techniques. Resistors 161-163 can have various suitable resistances, and can be configured to facilitate desired circuit functionality. For instance, circuit configuration 160 can correspond to a door state detector. In particular, circuit configuration 160, in conjunction with one or more suitable sensor devices, can be configured to facilitate the transmission of one or more signals indicative of a unique resistance value associated with an open or closed state of a door, as detected by the one or more sensor devices.

While the present subject matter has been described in detail with respect to specific exemplary embodiments and methods thereof, it will be appreciated that those skilled in the art, upon attaining an understanding of the foregoing may readily produce alterations to, variations of, and equivalents to such embodiments. Accordingly, the scope of the present disclosure is by way of example rather than by way of limitation, and the subject disclosure does not preclude inclusion of such modifications, variations and/or additions to the present subject matter as would be readily apparent to one of ordinary skill in the art.

What is claimed is:

1. A sensor interface board comprising:
a printed circuit board having a circuit pattern comprising one or more conductive traces and a plurality of electrical contact points, the one or more traces configured to couple together at least two contact points of the plurality of contact points, the printed circuit board further having a plurality of terminal screw holes, wherein at least one of the plurality of electrical contact points is associated with a terminal screw hole;
one or more connectors located on the sensor interface board, the one or more connectors configured to couple a sensor device to at least one electrical terminal associated with an electrical component via at least a portion of the circuit pattern of the printed circuit board;
wherein, the sensor interface board is configured to be secured in place relative to the electrical component by one or more terminal screws configured to fit in the plurality of terminal screw holes, and wherein, when the one or more terminal screws are tightened, a conductive path is formed between the sensor device and the electrical component.

2. The sensor interface board of claim 1, wherein the circuit pattern is configured to facilitate the transmission of a signal indicative of a level of vibration detected at least in part by the sensor device.

3. The sensor interface board of claim 1, wherein the circuit pattern is configured to facilitate the transmission of a signal indicative of an open or closed state of a door detected at least in part by the sensor device.

4. The sensor interface board of claim 1, wherein the circuit pattern further includes at least one resistor, capacitor, transistor, diode, or integrated circuit chip.

5. The sensor interface board of claim 1, wherein the sensor device is configured to detect data relating to at least one of temperature, flow, vibration, pressure, motion or weather.

6. The sensor interface board of claim 1, wherein the sensor device has one or more leads that terminate in a sensor connector configured to fit in at least one of the one or more connectors located on the sensor interface board.

7. The sensor interface board of claim 1, wherein the one or more connectors located on the sensor interface board are miniaturized connectors.

8. The sensor interface board of claim 1, wherein the electrical component is a battery adapter configured to receive a battery module associated with a wireless transmitter.

9. A system for coupling one or more sensor devices to a wireless transmitter, the system comprising:
one or more sensor devices;
a wireless transmitter configured to wirelessly transmit one or more signals received from at least one of the one or more sensor devices to a remote computing device; and
a sensor interface board having a circuit configuration comprising one or more conductive traces bridging one or more electrical contact points located on the sensor interface board, the sensor interface board further having one or more miniaturized connectors, each coupled to at least one of the electrical contact points, the miniaturized connectors configured to receive a sensor connector associated with at least one of the one or more sensor devices, such that when one or more terminal screws are tightened into one or more terminal screw holes located on the sensor interface board, a conductive path is formed between the at least one sensor device and one or more electrical terminals via at least a portion of the circuit configuration.

10. The system of claim 9, wherein the sensor interface board is mounted to one or more electrical devices associated with the wireless transmitter, the one or more electrical devices configured to receive a battery module associated with the wireless transmitter.

11. The system of claim 10, wherein the sensor interface board is secured in place relative to the one or more electrical devices by tightening the one or more terminal screws such that a conductive contact is made between the one or more electrical terminals and the at least one electrical contact point.

12. The system of claim 9, wherein the circuit configuration is configured to facilitate the transmission of a signal indicative of a level of vibration detected by the one or more sensor devices.

13. The system of claim 9, wherein the circuit configuration is configured to facilitate the transmission of a signal indicative of an open or closed state of a door detected at least in part by the one or more sensor devices.

14. The system of claim 9, wherein the circuit configuration further includes at least one resistor, capacitor, transistor, diode, or integrated circuits.

15. The system of claim 9, wherein the sensor device is configured to detect data relating to at least one of temperature, flow, vibration, pressure, motion or weather.
